(19) United States
(12) Patent Application Publication
(10) Pub. No.: US 2013/0080768 A1
(43) Pub. Date: Mar. 28, 2013

(54) SYSTEMS AND METHODS FOR SECURE COMMUNICATIONS USING AN OPEN PEER PROTOCOL

(71) Applicants: Erik Lagerway, North Vancouver (CA); Trent Johnsen, Calgary (CA)

(72) Inventors: Erik Lagerway, North Vancouver (CA); Trent Johnsen, Calgary (CA)

(21) Appl. No.: 13/369,356

(22) Filed: Feb. 9, 2012

Related U.S. Application Data
(60) Provisional application No. 61/539,197, filed on Sep. 26, 2011.

(51) Int. Cl. H04L 9/32

(52) U.S. Cl. 713/155; 713/176

(57) ABSTRACT

A cryptographic system and method for providing secure peer to peer communications over a network. The invention includes systems and methods for generating unique keys in a key-space, using a third party authentication system to provide identities for owners of those keys, proving the ownership of the keys, using a distributed database for establishing any kind of secure communication between two or more parties, and using the ownership of the keys in the key-space to establish secure communications

### CROSS-REFERENCE TO RELATED APPLICATION

This application claims priority to, and the benefit of, U.S. Provisional Patent Application No. 61/539,197, filed Sep. 26, 2011, the disclosure of which is hereby incorporated by reference in its entirety.

### BACKGROUND

1. Field of the Invention

The present invention relates generally to a cryptographic system and method for providing secure peer to peer communications over a network. The invention relates more specifically to systems and methods for generating unique keys in a key-space, using a third party authentication system to provide identities for owners of those keys, proving the ownership of the keys, using a distributed database for establishing secure communication among two or more parties, and using the ownership of the keys in the key-space to establish and confirm secure communications.

2. Description of the Related Art

Peer to peer (P2P) communication networks are often understood by those with ordinary skill in the art as providing many advantages over communication systems that utilize a centralized server. For instance, P2P networks offer greater network resilience because peers can communicate with each other even if a centralized server is offline. In this way, a P2P network increases robustness because it removes the single point of failure inherent in any client-server based system. P2P networks also offer increased privacy and security because they do not utilize centralized servers, which may be compromised and potentially allow eavesdropping on communications between peers. P2P networks also decrease administrative costs as there is no need to purchase, maintain and administer centralized servers.

In addition, P2P networks decrease bandwidth costs by relaying information directly from one peer to another without the need for the communication to be relayed through centralized servers and common ports. By distributing the processing, P2P networks make more efficient use of the resources by the clients, thus reducing or eliminating the need for powerful centralized hardware to meet the processing demands of the clients. As such, there is no risk of a centralized server becoming overloaded or unstable during peak loads.

However, P2P networks have not always lived up to these expected benefits. For instance, because of the modern use of firewalls within many local networks, a P2P network may require a publicly addressable intermediate server to initiate contact between two peers behind different firewalls. This intermediate server reduces some of the efficiencies gained in a P2P network environment.

Additionally, in P2P networks the average end user's machine must act as a server by utilizing bandwidth and spending resources to relay traffic for other users who “leech” off their bandwidth. Over time, the number of users willing to have their machines operate as servers for the benefit of others decreases, and those end users often implement measures to stop others from using their bandwidth. In one notorious example, Skype's network collapsed for this very reason and Skype responded by setting up its own super nodes.

Some P2P networks require specific ports to be opened on a firewall in order to operate. As an example, peers may register with Universal Plug and Play (UPnP)—a set of network protocols that permits networked devices to seamlessly discover each other's presence on a network and establish functional network services for data sharing communications, and entertainment—in order to open certain ports within the firewall automatically.

Unfortunately, many firewalls lack the ability to automatically open ports or actively disallow this feature for fear of creating network vulnerabilities, thus requiring users to open ports manually. However, only technically savvy individuals have the knowledge to manually open a port, and as such, these types of networks tend to be limited, and manual port management is not an effective universal solution.

Many P2P networks assume that mutual peers will not behave maliciously, which is often naïve. Networks that rely on such an assumption can be disrupted by a peer that does not act in a conforming manner, as the moment an evil node or cluster of evil nodes is injected into the peer network, parts or all of the network can suffer fatal issues or be security compromised.

One method for enhancing security in P2P networks is encryption. A variety of well known encryption techniques are currently implemented in P2P networks. For instance, the commonly known RSA crypto system can be used to encrypt messages over a P2P network. In this system, every user maintains a private key that is associated with a public key. Any user wishing to send a message to another user is able to look up the publicly available public key of the intended message recipient, and then encrypt the message using the recipient's public key. Only the intended recipient is able to decrypt the message, since only he has the private key associated with the public key. Often this initial message includes a symmetric key to be shared between the two users, such that the users can more efficiently communicate the remainder of the messages.

While the benefits of this type of encryption system are readily apparent, so too are the limitations. For instance, the RSA public key/private key system does not inherently include an “address book” mechanism whereby a user looking for another user can determine how to contact and/or communicate with that particular user. In essence, a “centralized” server is still required to initially establish the communications. In addition, because one of the keys is truly “public,” there is no notion of privacy should, for example, a user wish to block communications from another user.

Against this backdrop, a person having ordinary skill in the art readily understands the importance of developing more efficient systems and methods to implement a secure P2P communications network, particularly in light of the above considerations. Accordingly, the invention described herein provides systems and methods for securely communicating across a P2P network. The invention, which in the preferred embodiment is referred to herein as the “Open Peer Protocol,” addresses the realities of network architecture while delivering many functional benefits to end users.

### SUMMARY OF EXEMPLARY ASPECTS OF THE ADVANCEMENTS

Accordingly, a system and method is described that provides secure peer to peer communications over a network.

In one exemplary embodiment, a method is provided for generating a Key to be used as an identifier. The method includes the steps of generating a public key/private key pair; adding random salt to the public key and signing the public key with random salt to generate a signature; creating a package by combining the public key, random salt, and signature; and inputting the package into a hashing algorithm to generate the Key to be used as an identifier.

In another exemplary embodiment, a system is provided for generating a Key to be used as an identifier. The system includes a generating module for generating a public key/private key pair; a salting module for adding random salt to the public key; a signing module for signing the public key with random salt to generate a signature; a packaging module for creating a package by combining the public key, random salt, and signature; and a hash generating module for inputting the package into a hashing algorithm to generate the Key to be used as an identifier.

In a further embodiment, a method is provided for proving the identity of an owner of a Key within a Key-space. The method includes the steps of providing a Key owner with a one-time use value; receiving from the Key-owner a first package, the first package including the one-time use value and a digital signature of the one-time use value; receiving from the Key owner a second package, the second package including a public key that corresponds to a previously generated private key, and a digital signature of the public key; computing the hash value of the second package and comparing the hash value with a previously obtained Key to verify authenticity; and inputting the one-time use value, public key, and the digital signature of the one-time use value into a signature verifying algorithm to verify authenticity.

In one embodiment, the digital signature of the one-time use value is generated by the Key owner signing the one-time use value using the previously generated private key. In another embodiment, the second package further includes random salt, and the digital signature of the public key is generated by the Key owner signing the public key with the random salt using the previously generated private key. In yet another embodiment, the method further includes inputting the public key with the random salt, the public key, and the digital signature of the public key with the random salt into a signature-verifying algorithm to verify authenticity.

In another exemplary embodiment, a system is provided for proving the identity of an owner of a Key within a Key-space. The system includes a providing module for providing a Key owner with a one-time use value; a first package receiving module for receiving from the Key owner a first package, the first package including the one-time use value and a digital signature of the one-time use value; a second package receiving module for receiving from the user a second package, the second package including a public key that corresponds to a previously generated private key, and a digital signature of the public key; a hash value computing and comparison module for computing the hash value of the second package and comparing the hash value with a previously obtained Key to verify authenticity; and a first package signature verifying module for inputting the one-time use value, public key, and the digital signature of the one-time use value into a signature verifying algorithm to verify authenticity.

In one embodiment, the digital signature of the one-time use value is generated by the Key owner signing the one-time use value using the previously generated private key. In another embodiment, the second package further include random salt, and the digital signature of the public key is generated by the Key owner signing the public key with the random salt using the previously generated private key. In yet another embodiment, the system further includes a second package signature-verifying module for inputting the public key with the random salt, the public key, and the digital signature of the public key with the random salt into a signature-verifying algorithm to verify authenticity.

In another exemplary embodiment, a method is provided for providing identity proof of a Key owner through an authentication service. The method includes receiving proof of authentication from at least one of the Key owner and the authentication service; receiving a first package from the Key owner, the first package including a publicly available identifier associated with the authentication service, a Key associated with the owner, and a digital signature of the publicly available identifier and the Key; using a signing algorithm to sign the first package using a certificate, thereby generating a digital signature of the first package; and providing a second package to the user, the second package including the first package and the digital signature of the first package.

In one embodiment, the digital signature of the publicly available identifier and the Key is generated by the Key owner signing the publicly available identifier and the Key using a previously generated private key. In another embodiment, the method further includes computing a hash value of the second package and storing said hash value.

In yet another embodiment, the method further includes providing the Key owner with a one-time use value; receiving from the Key owner a third package, the third package including the one-time use value and a digital signature of the one-time use value; receiving from the Key owner a fourth package, the fourth package including a public key that corresponds to a previously generated private key, and a digital signature of the public key; receiving from the Key owner the second package; computing a hash value of the fourth package and comparing said hash value with a previously obtained Key to verify authenticity; inputting the one-time use value, the public key, and the digital signature of the one-time use value into a signature-verifying algorithm to verify authenticity; and inputting the second package and the public key into a signature-verifying algorithm to verify authenticity.

In one embodiment, the digital signature of the one-time use value is generated by the Key owner signing the one-time use value with the previously generated private key. In another embodiment, the fourth package further includes random salt, and the digital signature of the public key is generated by the Key owner signing the public key with the random salt using the previously generated private key. In yet another embodiment, the method further includes inputting the public key with the random salt, the public key, and the digital signature of the public key with the random salt into a signature-verifying algorithm to verify authenticity.

In yet a further exemplary embodiment, a system is provided for providing identity proof of a Key owner through an authentication service. The system includes an authentication receiving module for receiving proof of user authentication from at least one of the Key owner and the authentication service; a first package receiving module for receiving a first package from the Key owner, the first package including a publicly available identifier associated with the authentication service, a Key associated with the owner, and a digital signature of the publicly available identifier and the Key; a digital signature module for using a signing algorithm to sign the first package using a certificate, thereby generating a digital signature of the first package; and a second package providing module for providing a second package to the Key owner, the second package including the first package and the digital signature of the first package.

In one embodiment, the digital signature of the publicly available identifier and the Key is generated by the Key owner signing the publicly available identifier and the Key using a previously generated private key. In another embodiment, the system further includes a hash value computing and storage module for computing the hash value of the second package and storing said hash value.

In yet another embodiment, the system further includes a value providing module for providing the Key owner with a one-time use value; a third package receiving module for receiving from the Key owner a third package, said third package including the one-time use value and a digital signature of the one-time use value; a fourth package receiving module for receiving from the Key owner a fourth package, said fourth package including a public key that corresponds to a previously generated private key, and a digital signature of the public key; a second package receiving module for receiving from the Key owner the second package; a hash value computing and comparison module for computing the hash value of the fourth package and comparing said hash value with a previously obtained Key to verify authenticity; a first package signature-verifying module for inputting the one-time use value, the public key, and the digital signature of the one-time use value into a signature-verifying algorithm to verify authenticity; and a second package signature-verifying module for inputting the second package and the public key into a signature-verifying algorithm to verify authenticity.

In one embodiment, the digital signature of the one-time use value is generated by the Key owner signing the one-time use value with the previously generated private key. In another embodiment, the fourth package further includes random salt, and the digital signature of the public key is generated by the Key owner signing the public key with the random salt using the previously generated private key. In yet another embodiment, the system further includes a third package signature-verifying module for inputting the public key with the random salt, the public key, and the digital signature of the public key with the random salt into a signature-verifying algorithm to verify authenticity.

In another exemplary embodiment, a method is provided for proving the identity of a Key owner. The method includes providing the Key owner with a one-time use value; receiving from the Key owner a first package; receiving from the Key owner a second package; receiving from the Key owner a third package; computing the hash value of the second package and comparing the hash value with a previously obtained Key to verify authenticity; inputting the one-time use value, public key, and the digital signature of the one-time use value into a signature verifying algorithm to verify authenticity; inputting the public key with random salt, public key, and the digital signature of the public key with random salt into a signature verifying algorithm to verify authenticity; and inputting the publicly available identifier, the Key, the digital signature of the publicly available identifier and the Key, and the authentication service digital signature into a signature verifying algorithm to verify authenticity.

The first package includes the one-time use value and a digital signature of the one-time use value, with the digital signature being generated by the Key owner signing the one-time use value with a previously generated private key. The second package includes a public key with random salt and a digital signature of the public key with random salt, with the digital signature of the public key with random salt being generated by the user signing the public key with random salt using the previously generated private key. And the third package includes: a publicly available identifier associated with an authentication service; a Key associated with the Key owner; a digital signature of the publicly available identifier and the Key, the digital signature of the publicly available identifier and the Key generated by the user signing the publicly available identifier and the Key using a previously generated private key; and an authentication service digital signature of the publicly available identifier, the Key, and the digital signature of the publicly available identifier and the Key. The authentication service digital signature of the publicly available identifier, the Key, and the digital signature of the publicly available identifier and the Key is generated by the authentication service signing the publicly available identifier, the Key, and the digital signature of the publicly available identifier and the Key using the Key owner's public key.

In another exemplary embodiment, a system is provided for proving the identity of a Key owner. The system includes a providing module for providing the Key owner with a one-time use value; a first package receiving module for receiving from the Key owner a first package; a second package receiving module for receiving from the Key owner a second package; a third package receiving module for receiving from the Key owner a third package; a hash value computing and comparison module for computing the hash value of the second package and comparing the hash value with a previously obtained Key to verify authenticity; a first package signature verifying module for inputting the one-time use value, public key, and the digital signature of the one-time use value into a signature verifying algorithm to verify authenticity; a second package signature verifying module for inputting the public key with random salt, public key, and the digital signature of the public key with random salt into a signature verifying algorithm to verify authenticity; and a third package signature verifying module for inputting the publicly available identifier, the Key, the digital signature of the publicly available identifier and the Key, and the authentication service digital signature into a signature verifying algorithm to verify authenticity.

The first package includes the one-time use value and a digital signature of the one-time use value, with the digital signature being generated by the Key owner signing the one-time use value with a previously generated private key. The second package includes a public key with random salt and a digital signature of the public key with random salt, with the digital signature of the public key with random salt being generated by the user signing the public key with random salt using the previously generated private key. And the third package includes: a publicly available identifier associated with an authentication service; a Key associated with the Key owner; a digital signature of the publicly available identifier and the Key, the digital signature of the publicly available identifier and the Key generated by the user signing the publicly available identifier and the Key using a previously generated private key; and an authentication service digital signature of the publicly available identifier, the Key, and the digital signature of the publicly available identifier and the Key. The authentication service digital signature of the publicly available identifier, the Key, and the digital signature of the publicly available identifier and the Key is generated by the authentication service signing the publicly available identifier, the Key, and the digital signature of the publicly available identifier and the Key using the Key owner's public key.

In yet a further exemplary embodiment, a distributed database system is provided for use in a peer to peer communication network. The system includes a plurality of finder databases. The plurality of finder databases are used to store at least a peer name, Key associated with said peer, and a network location of said peer. The Key is generated by first generating a public key/private key pair; then adding random salt to the public key; signing the public key with random salt to generate a signature; creating a package by combining the public key, random salt, and signature; and inputting the package into a hashing algorithm to generate the Key to be used as an identifier.

It is to be understood that both the foregoing general description of the invention and the following detailed description are exemplary, but are not restrictive, of the invention.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings, wherein:

FIG. 1 illustrates a process flow diagram for generation of a hash value to use as a Key in a Key-space;

FIG. 2a illustrates a process flow diagram by which the provider of an authentication system (or a trusted third party) may use an existing authentication system to prove the identity of the owner of a Key within a Key-space;

FIG. 2b illustrates a detailed diagram corresponding to the processes in FIG. 2a;

FIG. 3a illustrates a process flow diagram for using a trusted third party to provide identity proof for an authentication service;

FIG. 3b illustrates a detailed diagram corresponding to the processes in FIG. 3a;

FIG. 4a illustrates a process flow diagram for the owner of a Key to prove his identity to a challenger;

FIG. 4b illustrates a detailed diagram corresponding to the processes in FIG. 4a;

FIG. 5a illustrates a process flow diagram for establishing a secure channel for communications;

FIG. 5b illustrates a detailed diagram corresponding to the processes in FIG. 5a; and

FIG. 6 illustrates a network diagram for using a distributed database for establishing a secure connection between peers.

### DETAILED DESCRIPTION

Embodiments of the present invention are directed to systems and methods for providing secure peer to peer communications over a network. As explained in more detail below, this new “Open Peer Protocol” provides a flexible and secure method for P2P network communications. In general, the Open Peer Protocol allows any peer to connect to any other peer (if authorized), and takes a design approach that strongly considers the integration of firewalls. The Open Peer Protocol also allows additional services to be layered on top of the architecture, while considering the need not always to have peer machines acting as super nodes for the network. The Open Peer Protocol enables peers to find one another by providing directory services while enabling secure P2P communications among the peers that allows for trusted identity assertions. The present invention also allows of the establishment of “private peers,” which is akin to having an unlisted phone number that does not appear in the public phone book.

In addition to the above benefits, the Open Peer Protocol allows for differing peer architectures (e.g., peer to peer self-organized models and centralized network layouts to be abstracted from the protocol), reduces the need for signed certificates from a known authority for each peer on the network (or for those machines acting as peer servers), and reduces the need for individual users to configure firewall ports under ordinary circumstances.

In accordance with the descriptions of the exemplary systems and methods described herein, one with ordinary skill in the art would readily understand that the below-described systems and methods are flexible and do not limit the claimed invention. Rather, the preferred embodiment is described as an example of one way in which the claimed systems and methods may be implemented.

Accordingly, certain terminology is necessary to provide a foundation in understanding the preferred embodiment of the claimed systems and methods.

As used herein, “identity” refers to a unique representation of a peer, whether the peer be a real person or a representative entity (e.g., corporation). An identity can reside at zero or more peer locations.

As used herein, the term “asserted identity” means an identity which can be verified through an identity service as being the rightful owner of the identity (rather than a fraudulent representation). In other words, an asserted identity can always be trusted—to the extent the identity service can be trusted—and a user can always be certain that an asserted identity is who they claim to be. Different levels of identity assertion can be claimed for any given identity (e.g., no assertion at all, weak assertion, or strong assertion).

As used herein, the term “peer” refers to the representation of a single point of contact on the Internet for an identity. Typically, a peer will be a single machine connected as a leaf on the Internet. A peer can have zero or more identities residing at a single peer location.

As used herein, the term “peer URI” refers to a universal resource identifier beginning with “peer:” and offering the ability to locate a specific identity, resource, protocol and request type within a peer bootstrapped network.

As used herein, the term “peer finder” refers to a machine service which tracks peer locations and their associated identities as they are dispersed throughout the network. The peer finder may utilize a database (either centralized or distributed), to instantiate the communication between peers.

As used herein, the term “bootstrapper” refers to an introductory server to which peers first communicate in order to be introduced to one (or more) peer finders. In particular implementations, peers should first attempt to connect to introduced peer finders in order to gain entry to the peer networks. Once a peer is connected to a bootstrapped network, the peer no longer requires communication back to the bootstrapper unless access to a previously introduced or discovered peer finder is no longer accessible.

As used herein, the term “bootstrapped network” refers to the representation of the entire peering network that was introduced from a bootstrapper.

As used herein, the term “peer service” refers to any additional service that is offered to peers, examples of which include identity assertion, completely automated public Turing test to tell computers and humans apart (CAPTCHA), traversal using relay network address translator (TURN), and video conferencing.

As used herein, the term “dot peer file” refers to a file that contains information required to locate an identity within a peer network and authorize a connection to that peer. Any peer without the correct dot peer file from another identity is unable to connect to the peer having that identity. A directory service can host and offer these files between peers, but without the dot peer file no communication is possible. This file also contains the information necessary to allow completely secure communication between peers reducing the possibility of a man-in-the-middle attack. Additionally, this file contains all of the asserted identities contained for the associated identity which can then be verified.

As used herein, the term “Key” refers to a unique identifier that corresponds to a specific peer in the network. More specifically, in the preferred embodiment, the term Key is the output of a hash algorithm that also identifies a peer in the network.

It is understood that the methods and systems described below may contain software and hardware connected to the Internet via a network. Computing devices are capable of communicating with each other via the Internet, and it should be appreciated that the various functionalities of the components may be implemented on any number of devices.

A communications network generally connects a client with a server, and in the case of peer to peer communications, connects two peers. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on. Preferably, the network can carry TCP/IP protocol communications, and HTTP/HTTPS requests made by a web browser and the connection may be made between the peers and communicated over such TCP/IP networks.

The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet 16, which may accommodate many different communications media and protocols.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although internal components of the computer are not shown, those of ordinary skill in the art will appreciate that such components and the interconnections are well known. Accordingly, additional details concerning the internal construction of the computer need not be disclosed in connection with the present invention.

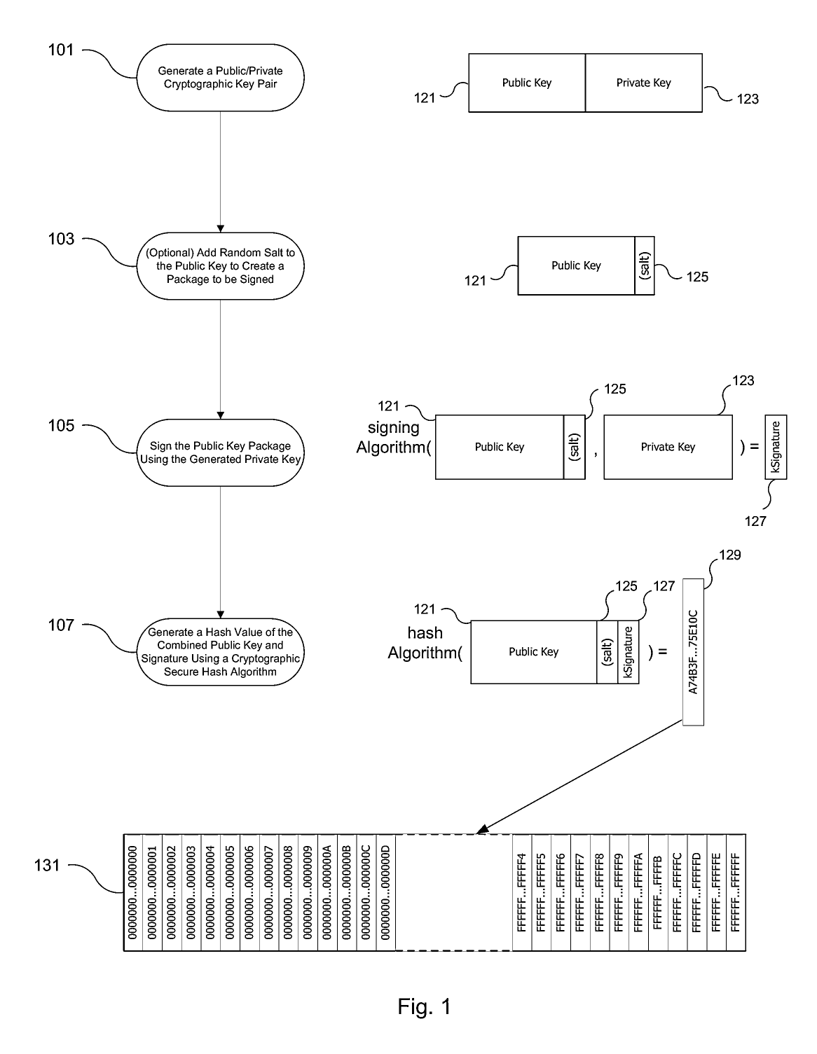

FIG. 1 illustrates one exemplary method for generating a Key for use in the cryptographic systems described herein. As shown in FIG. 1, a Key can be generated by performing the following steps. First, a user needing a Key for use in the communication system (owner) can use any of the widely known systems to generate a public key 121 private key 123 pair as shown in step 101. Well known algorithms for generating a public key 121 private key 123 pair include Diffie-Hellman, RSA, and various elliptic curve techniques, however, a person with ordinary skill in the art would readily understand that any public key 121 private key 123 generation system may be used.

Once the public key 121 private key 123 pair is generated, the public key can be used as a message in a digital signature signing algorithm to generate a signature, as shown in step 105. Optionally, a password salt 125 can be added into the public key 121 message being signed, as shown in step 103. In this way, the signing algorithm is provided with two parameters: the message itself to be signed (public key 121 and optional salt 125), and the private key 123. This signing algorithm outputs a digital signature, referred to as “kSignature” 127 that demonstrates the authenticity of the message (public key 121 and optional salt 125).

In step 107, the message (public key 121 and optional salt 125) is packaged with the output of the signing algorithm (signature 127), in order to create a package to be input into a hashing algorithm. The cryptographic hash function takes the data package and returns a fixed-size bit string called the hash value or “Key” 129. This output Key 129 is then one unique value in a set of Keys called a Key-space 131. The Key-space 131 is understood to be a collection of Keys wherein each Key is unique within the Key-space 131 domain. Certain well known methods can be used in order to ensure that a collision does not occur in generating the Keys that comprise the Key-space 131.

For convenience, each Key 129 in the Key-space 131 of FIG. 1 is represented by a unique number in hexadecimal form. The possible representation of key values starts at zero and advances to some maximum value. A person with ordinary skill in the art would understand that the key value needs to only be as large as is required for statistical improbability of any two generated keys colliding in the given Key-space 131.

Once the Key 129 has been generated by the Key owner, any third party authentication system can be used to prove the identity of the owner of the Key 129 within the Key-space 131.

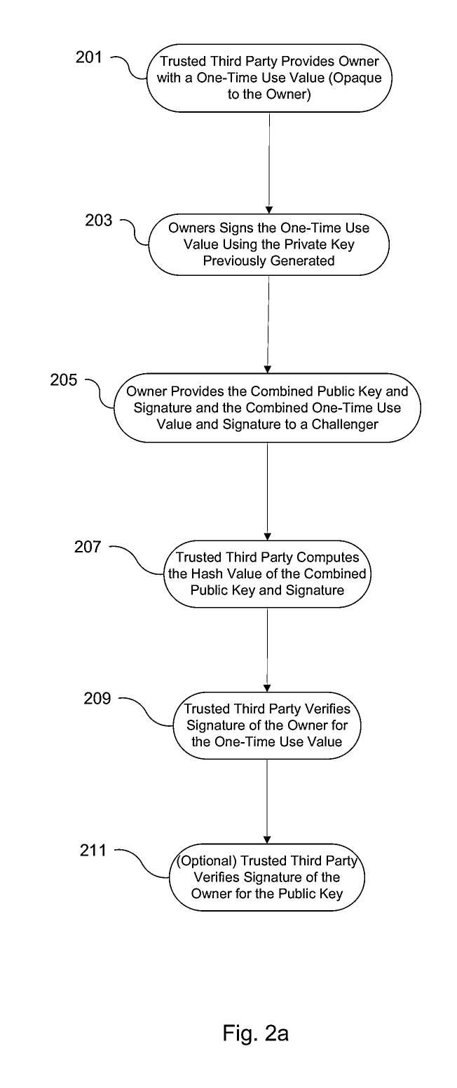

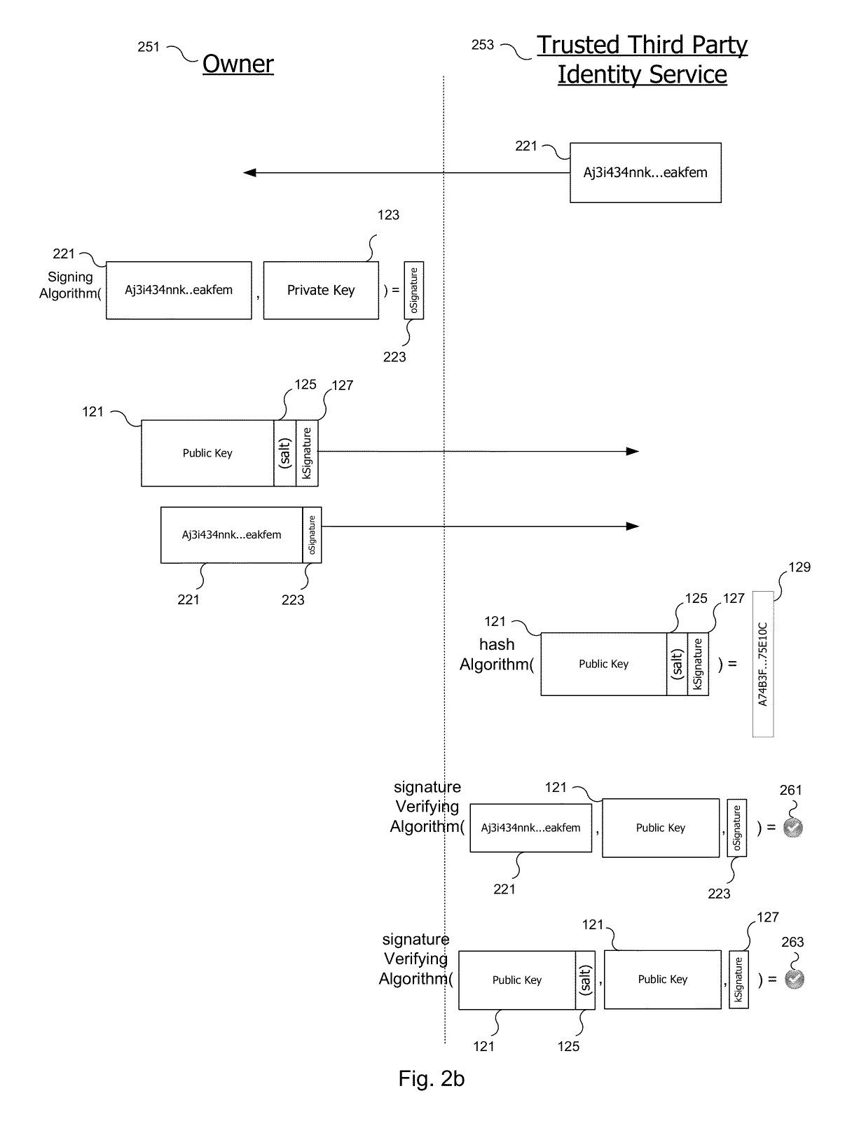

FIGS. 2a and 2b, in conjunction with the description below, describe how the provider of an authentication system (or a trusted third party) can use an existing authentication system to prove the identity of the owner of the Key 129 within the Key-space 131. For purposes of FIG. 2b, it is understood that a third party entity 253 provides the proof of identity, however, this third party entity 253 may be the same entity as the entity providing the authentication system itself.

In addition, it is to be understood that the trusted third party identity service 253 shown in FIG. 2b and described below can also be substituted with a challenger in a peer to peer communication network.

Referring to FIG. 2a, in step 201, the trusted third party identity service 253 provides the owner 251 of the Key 129 within the Key-space 131 with a one-time use value 221 that is opaque to the owner. Persons with ordinary skill in the art will readily understand ways in which one-time use values can be generated. The Key owner 251 then proceeds to sign the opaque one-time use value 221 using his own private key 123 previously generated (and associated with his public key) 121. Persons with ordinary skill in the art readily understand that a digital signature algorithm takes in as parameters a message and a private key, and outputs a signature. In this way, the message is the opaque one-time value 221, and the private key is the private key 123 previously generated and associated with the owner's public key 121. The signing algorithm will output a signature, namely “oSignature” 223 as shown in step 203 in FIG. 2a.

The Key owner 251 then provides the combined public key 121 (with optional salt 125) and signature (“kSignature” 127) package to the trusted third party identity service 253. The Key owner 251 also provides the combined opaque one-time value 221 and signature (oSignature 223) package to the trusted third party identity service 253. This is shown in step 205. In alternative embodiments, it is possible to only provide the trusted third party service with one package such that single verification can be accomplished. However, in the preferred embodiment both the public key package as well as the opaque one-time value package are provided to the trusted third party service 253.

Upon receipt of the package(s), the trusted third party service 253 computes a hash value of the combined public key 121 with optional salt 125 and signature (kSignature 127), as shown in step 207. This hash algorithm should output the output Key 129 in FIG. 1, assuming that the information provided is correct. In this manner, use of the same Key 129 from the Key-space 131 has been ensured.

In step 209, the trusted third party identity service 253 uses a signature verifying algorithm to ensure that the oSignature 223 matches to the opaque one-time value 221 given the public key 121 provided by the owner 251. This signature verifying algorithm either accepts or rejects the message's authenticity claim. Similarly, in optional step 211 the trusted third party 253 verifies the signature (kSignature 127) of the owner for the public key 121 using a signature verifying algorithm. Once these verifications have been performed, the trusted third party identity service 253 (and/or challenger) can be confident that the identity for the ownership of the Key 129 has been authenticated.

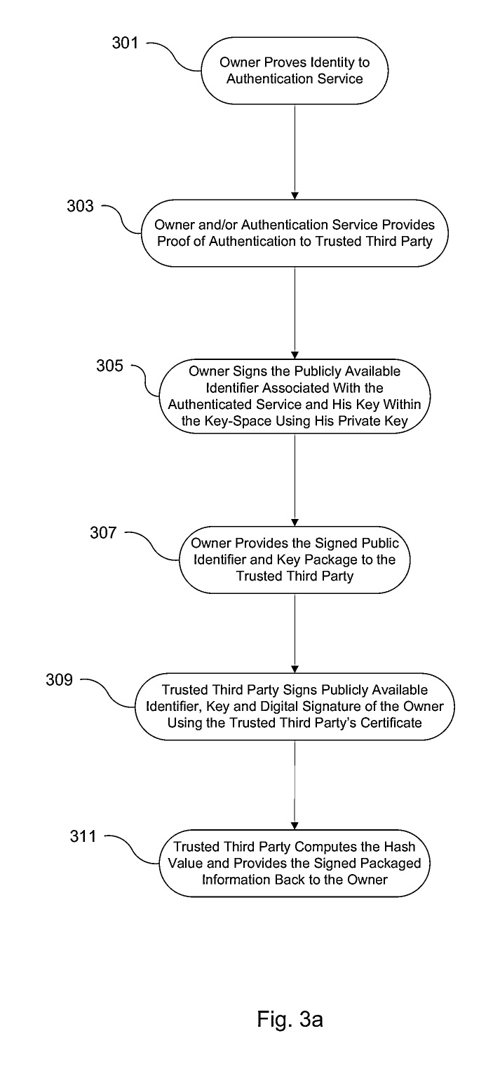

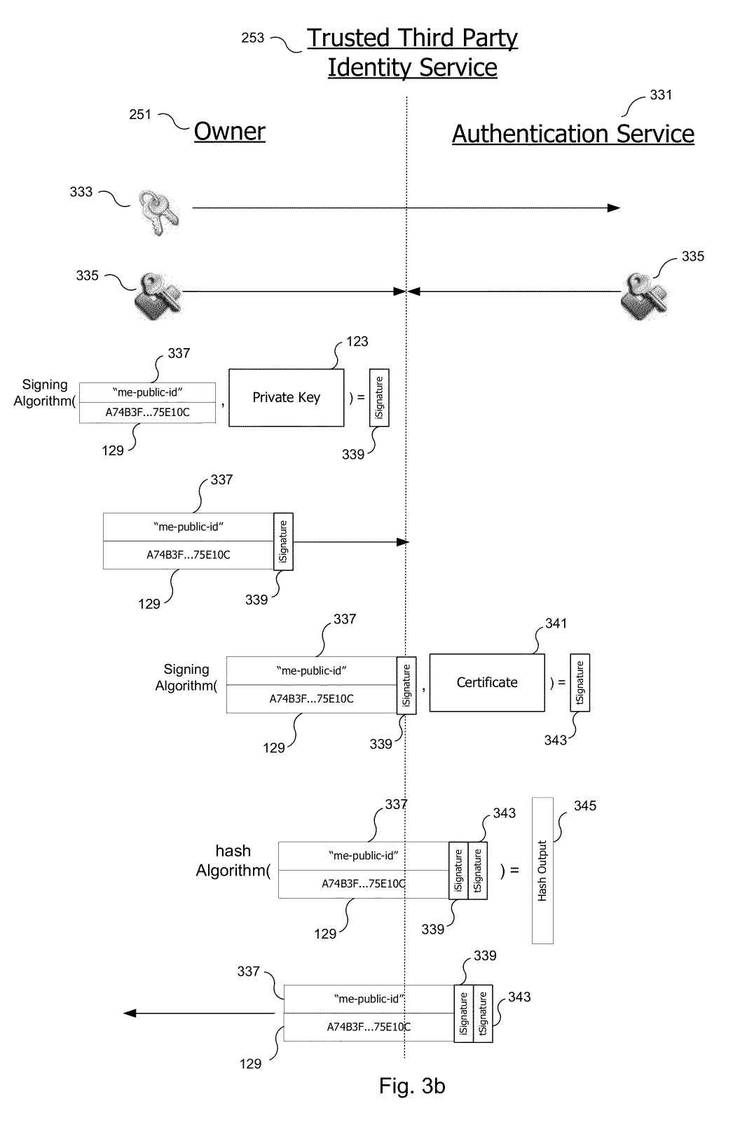

FIGS. 3a and 3b show an exemplary embodiment of the present invention for using a trusted third party 253 to provide proof of identity for an authentication service 301. Specifically, FIGS. 3a and 3b illustrate how a trusted third party service 253 can provide proof of the identity of the owner of a Key 129 within the Key-space 131.

In step 301, the owner 251 first proves its identity to the authentication service 331, using whatever established techniques as provided by the authentication service 331. Persons having ordinary skill in the art will understand the various techniques that could be used by the authentication service to prove the owner's identity. Once the owner 251 has proven his identity 333 to the authentication service 331, at that point either the owner 251 or the authentication service 331 can provide this proof of authentication 335 to the trusted third party identity service 253, as shown in step 303. In another embodiment, this proof of authentication 335 may come from both the owner 251 and the authentication service 331.

In step 305, the owner 251 combines a publicly available identifier 337 associated with the authentication service 331 and his own Key 129 within the Key-space 131, and signs this combination using his private key 123 to generate a new signature (“iSignature” 339).

Next, the owner 251 provides the signed (with iSignature 339) public identifier 337 and Key 129 package to the trusted third party identity service 253, as shown in step 307.

The trusted third party 253 then signs the entire package received from the owner 251 (the package including the publicly available identifier 337 associated with the authentication service 331 and the owner's own Key 129 within the Key-space 131 and the iSignature 339), using its own certificate 341 as a private key. The output from this signing algorithm with that input generates a new signature (“tSignature” 243), as shown in step 309.

Next, in step 311, the trusted third party service 253 combines the package received from the owner 251 with the newly generated signature (tSignature 243) using his own certificate 341, and computes the hash value output 345. This computed hash value 345 is optional, and may be stored by the trusted third party identity service 253 for its own purposes. The trusted third party 253 then provides a package back to the owner 251 which includes the publicly available identifier 337 associated with the authenticated service, the owner's own Key 129 within the Key-space 131, the iSignature 339, and the newly generated tSignature 243.

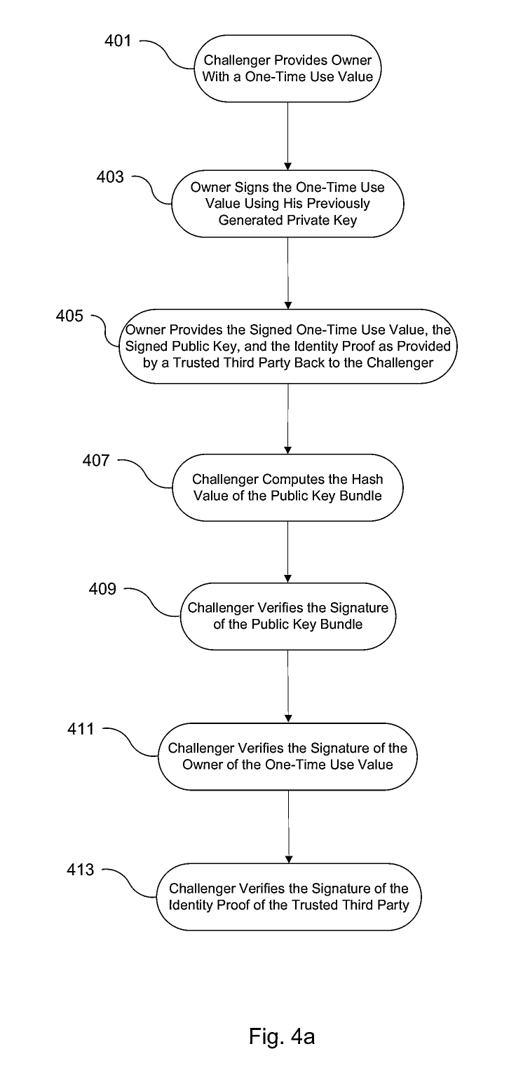

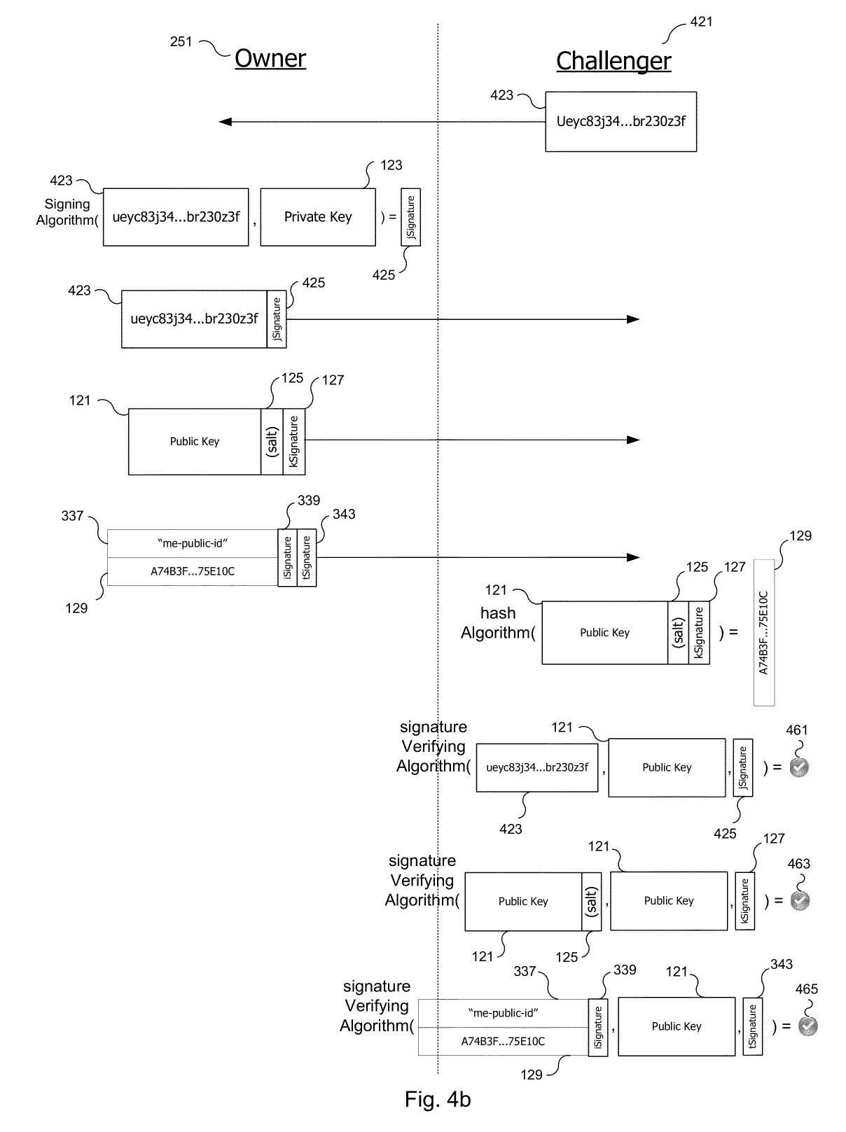

This package, now called the identity proof, may be used by the owner 251 to prove his identity as explained further with reference to FIGS. 4a and 4b.

FIGS. 4a and 4b show an exemplary embodiment of the present invention in which the identity proof can be validated by an external entity (i.e., challenger). In step 401, the challenger 421 first provides a one-time use value 423 to the owner 251 that is opaque to the owner 251. Next, in step 403 the owner 251 signs the one-time use value 423 using his previously generated private key 123. This signing algorithm uses the owner's private key 123 and generates signature j Signature 425. Next, owner 251 provides a series of packages to challenger 421 that allows challenger 421 to validate the identity proof provided to the owner 251 by the trusted third party identity service 253.

In step 405 the owner 251 provides the signed 425 opaque one-time use value 423 package, the signed 127 public key 121 with optional salt 125 package, and the signed 343 identity proof (337, 129, and 339) to the challenger 421. The challenger 421 is first able to compute the hash value of the public key bundle (121, 125, and 127) in order to ensure that the same Key 129 in the Key-space 131 is output, as shown in step 407. Next, the challenger 421 is able to ensure that the signatures (425, 127, and 343) for each of the packages received from the owner 251 are verified, each in turn. If each of the signatures pass the signature verifying algorithm (461, 463, and 465), then the owner 251 has proved ownership and identity of the Key 129 in the Key-space 131.

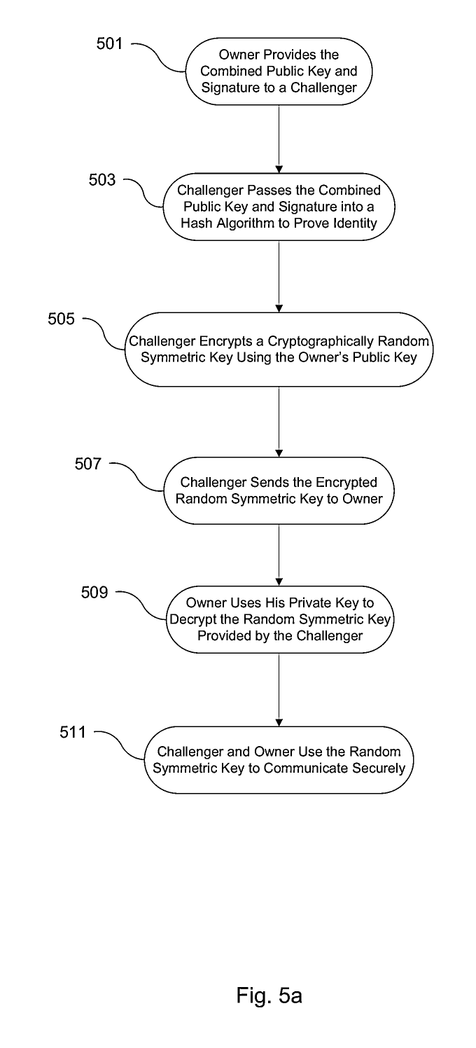

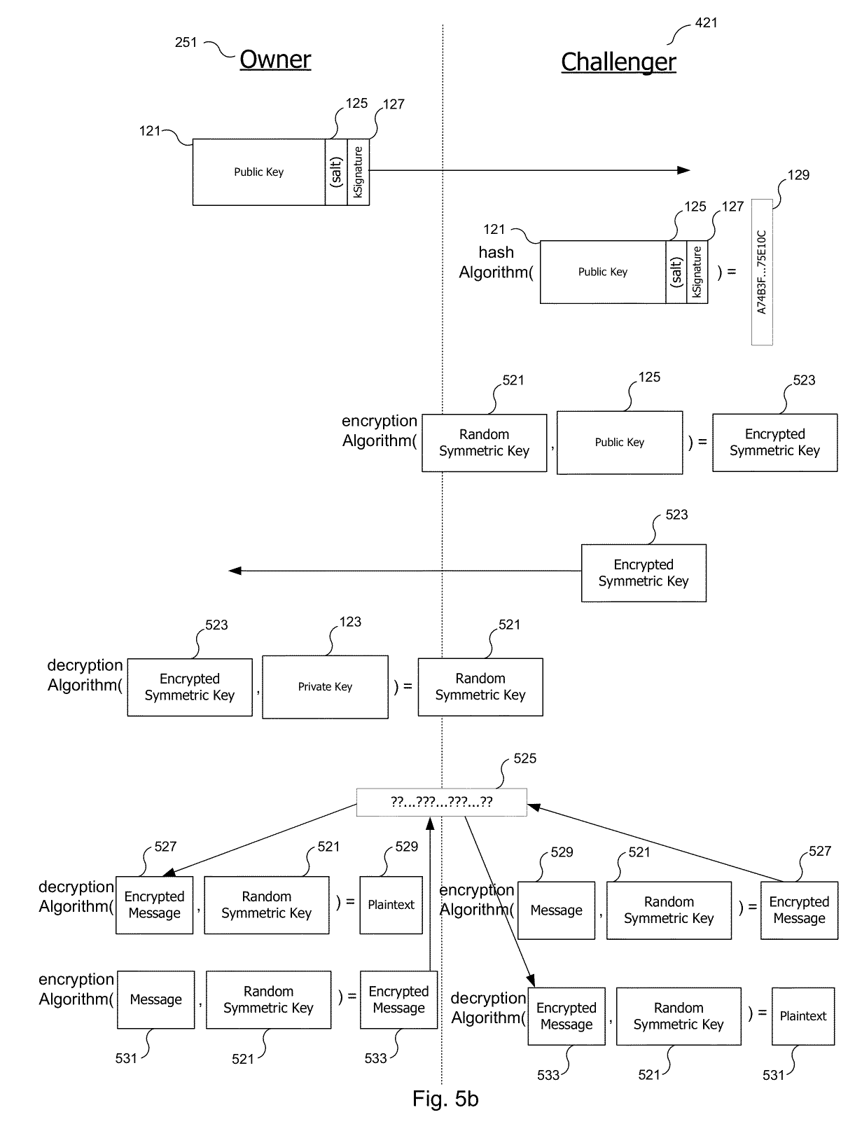

Now that the owner 251 has proved ownership and identity of the Key 129 in the Key-space 131, FIGS. 5a and 5b shows how the owner and a challenger can open up secure communications in a peer to peer network. Notably, this process describes how to open a secure communication between the owner 251 of a Key 129 in a Key-Space 131 and another peer without the user of a signing authority.

In the below description, it is assumed that the challenger 421 (entity to communicate with the Key owner 251) knows the owner's asserted Key 129, possibly by looking it up in a directory, possibly by being provided the Key 129 from the owner 251, or else by any other well known means. In any event, it is assumed that the challenger 421 knows the Key 129. It is also assumed for purposes of the explanation below that proof of ownership of the Key 129 can established. Finally, it is assumed that the owner 251 has previously generated a public key 121 private key 123 pair, as explained above.

The secure communication process begins in step 501 as the owner 251 provides his combined public key 121 package (including the optional salt 125 and signature, kSignature 127) to the challenger 421. The challenger 421 then runs this combined package through a cryptographic hash function to prove that the public key 121 is the same public key as the previously known public key (if the hash output matches the Key 129). This is shown in step 503.

Assuming that the public key 121 package is verified, the challenger 421 then generates a random symmetric key 521, the generation of which is well known to those with ordinary skill in the art. Examples of commonly used symmetric key algorithms include AES, DES, Triple DES, Blowfish, Serpent, and Twofish. The challenger 421 then uses the owner's verified public key 125 to encrypt the random symmetric key 521, which creates an encrypted symmetric key 523 (step 505). Once the challenger 421 has the encrypted symmetric key 523, he sends this encrypted symmetric key 523 to the owner 251 (step 507).

The owner 251, as the only entity in possession of the private key 123 that that corresponds to the public key 125 used to encrypt the symmetric key 521, is then able to use a decryption algorithm that takes the encrypted symmetric key 523 and private key 123 as input, and produces the unencrypted symmetric key 521 as output (step 509).

Now, since the owner 251 and challenger 421 share a symmetric key 521, they can open a secure line of communications 525 and are able to use the symmetric key 521 to encrypt plaintext messages (529 and 531) to generate encrypted messages (527 and 533), transmit those encrypted messages (527 and 533) over the secure line 525, and then decrypt the encrypted messages received from the other party. This entire process is represented as step 511 in FIG. 5a.

Since the proof of Key 129 ownership was performed before the secure communication 525 was established, the parties can be sure that an eavesdropping third party has not substituted its own public key during the initial exchange processes and is sitting in the middle listening to the secure communication 525.

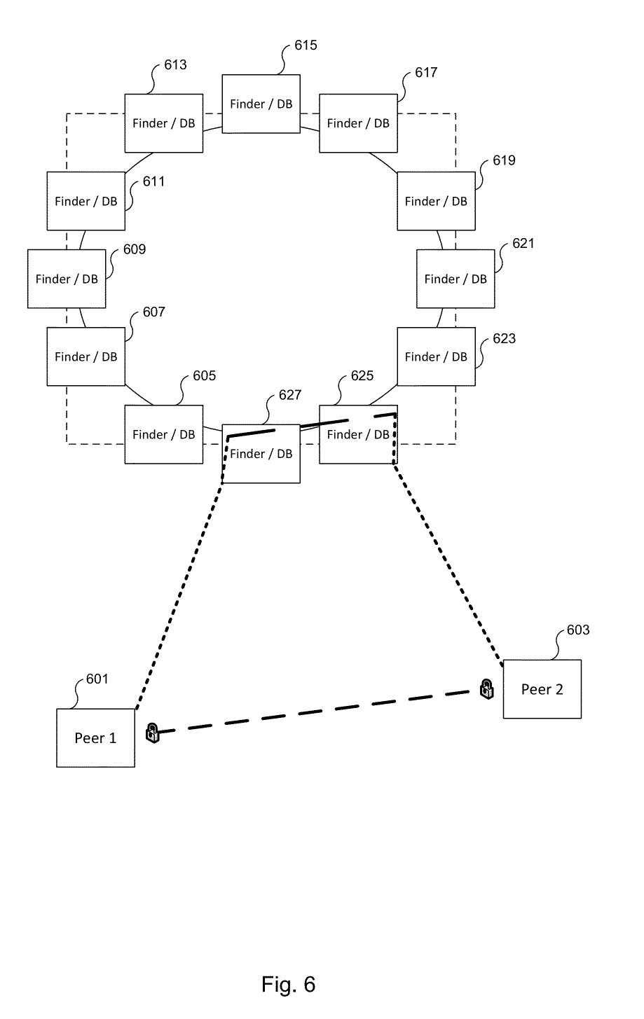

The above encryption systems and methods are applicable to any communication network, but in a preferred embodiment, they will be utilized in a peer to peer communication network. For example, in accordance with FIG. 6, a distributed database is shown for establishing any kind of communication between two (or more) parties.

A distributed database typically distributes the Keys amongst a Key-space and spreads the data across multiple machines (605, 607, 609, 611, 613, 615, 617, 619, 621, 623, 625, and 627) so that the failure of any one of the machines does not render the process ineffective. In the example shown in FIG. 6, a ring topology is shown, however, a person having ordinary skill in the art would understand that other topologies such as a mesh, star, or tree structure (or any other topology) could also be used. In any event, each Finder/DB machine in the topology does not maintain the entire Key-space, but rather only a subset of the Keys. In this way, the ring style implementation is used to distribute the data amongst the database and is thus used to help peers (601 and 603) find each other and establish secure communications with each other and/or other peers.

In the preferred embodiment, each database (Finder/DB) stores at least a name and value pairing. The name would be, for instance, “me-public-id” (see FIG. 3, 337), and the value, would be, for instance the Key 129 “A74B3F . . . 75E10C”. The distributed databases will also store the location for each of the peers (matching the name/value pair). In this way each peer has registered his own Key within the distributed database system to indicate where he is located within the network. The peer may also maintain a permanent connection to any one of the database machine(s) as direct peer communication may not be possible due to firewalls.

When trying to find Peer 2 603, Peer 1 601 may ask the peer Finder/DB 627 to find the remote Peer 2 603 based on the Peer 2's Key in the database 625. The initial bootstrap Finder/DB 627 will relay the request to the peer Finder/DB 625 where the Peer 2 603 is registered. The Finder/DB 627 will also deliver connectivity information to Peer 2 through the Finder/DB 625 in this manner. The remote Peer 2 603 will respond and send connectivity information back to the Finder/DB to which it is registered 625, which will in turn relay the information back to Peer 1 601 thorough Finder/DB 627. Once the connectivity information has been exchanged, the peers are then able to open up a secure channel of communication.

In a preferred embodiment, the dot peer file contains information required to locate, connect and establish a secure channel between peers and the identity represented within the file. In a preferred embodiment, the dot peer file is made up of up three sections—“Section A,” “Section B,” and “Section C.” Section A can be transmitted to any third party and permits any third party to determine the identity's “search hash” as well as the identity's public key, in order to prove ownership. Section B allows for a different peer to find the peer and initiate contact. Section B can be withheld from any peer if the peer does not wish to be found. Section C is used to prove identities of the contact. This section can be provided or withheld depending on how anonymous the peer wishes to be.

The entire dot peer file (Sections A, B and C) is only given to third parties that are permitted to communicate directly with the peer. At a minimum, Section A is required in order to establish a secure communication channel between peers. Also, Section B is required to allow a peer to be found by another peer, and Section C is required to prove identities of the peer.

Example dot peer file:

<peer version=”1”>
<sectionBundle>
<section id=”A”>
<cipher>sha1/aes256</cipher>
<saltBundle>
<salt id=”cf9c4688b014e13d8bdd2655912ffd3253f53768”>Z3nfnDenen29291mfde...21n</salt>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#cf9c4688b014e13d8bdd2655912ffd3253f53768”>
<DigestMethod Algorithm=“http://www.w3.org/2000/09/xmldsig#sha1”/>
<DigestValue>jeirjLrta6skoV5/A8Q38Gj4j323=</DigestValue>
</Reference>
</SignedInfo>
<SignatureValue>DEfGM~C0/Ez=</SignatureValue>
<KeyInfo><KeyName>CN=salt, S=349949323</KeyName></KeyInfo>
</Signature>
</saltBundle>
<data></data>
</section>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#A”>
<DigestMethod Algorithm=“http://www.w3.org/2000/09/xmldsig#sha1” />
<DigestValue>j6lwx3rvEPO0vKtMup4NbeVu8nk=</DigestValue>
</Reference>
</SignedInfo>
<SignatureValue>G4Fwe0E/YT=</SignatureValue>
<KeyInfo>
<X509Data>
<X509Certificate>MIID5jCCA0+gA...lVN</X509Certificate>
</X509Data>
</KeyInfo>
</Signature>
</sectionBundle>
<sectionBundle>
<section id=”B”>
<contact id=”ab43bd44390dabc329192a392bef1” />
<findSecret>YjAwOWE2YmU4OWNlOTdkY2QxNzY1NDA5MGYy</findSecret>
<uris>
<uri>peer://example.bootstrapper.com/contact:ab43bd44390dabc329192a392bef1</uri>
</uris>
</section>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#B”>
<DigestMethod Algorithm=“http://www.w3.org/2000/09/xmldsig#sha1”/>
<DigestValue>UrXLDLBIta6skoV5/A8Q38GEw44=</DigestValue>
</Reference>
</SignedInfo>
<SignatureValue>MC0E~LE=</SignatureValue>
</Signature>
</sectionBundle>
<sectionBundle>
<section id=”C”>
<contact id=”ab43bd44390dabc329192a392bef1” />
<uris>
<uri>peer://example.bootstrapper.com/alice@domain.com</uri>
<uri>peer://example.bootstrapper.com/provider:facebook:392302031</uri>
<uri>peer://example.bootstrapper.com/provider:twitter:booyah</uri>
</uris>
<identities>
<identity>
<proofBundle>
<proof id=”b5dfaf2d00ca5ef3ed1a2aa7ec23c2db”>
<service>identity-validation</service>
<type>email</type>
<serial>48438832</serial>
<unique>alice@domain.com</unique>
<name>Alice Q. Public</name>
<dataBundle>
<data id=”data”><contact id=”ab43bd44390dabc329192a392bef1” /></data>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#data”>
<DigestMethod Algorithm=“http://www.w3.org/2000/09/xmldsig#sha1”/>
<DigestValue>Z29yaXR21...ZXN0VmFsdWU+SVVl=</DigestValue>
</Reference>
</SignedInfo>
<SignatureValue>ICA8L1Np...Z25lZEluZm8+DQ=</SignatureValue>
</Signature>
</dataBundle>
</proof>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#b5dfaf2d00ca5ef3ed1a2aa7ec23c2db”>
<DigestMethod Algorithm=“http://www.w3.org/2000/09/xmldsig#sha1”/>
<DigestValue>IUe324koV5/A8Q38Gj45i4jddX=</DigestValue>
</Reference>
</SignedInfo>
<SignatureValue>MDAwMDAwMGJ5dGVzLiBQbGVhc2UsIGQ=</SignatureValue>
<KeyInfo><KeyName>CN=identity-validation, S=43438932</KeyName></KeyInfo>
</Signature>
</proofBundle>
</identity>
<identity>
<proofBundle>
<proof id=”b5dfaf2d00ca5ef3ed1a2aa7ec23c2db”>
<service>identity-validation</service>
<type>twitter</type>
<serial>5883232</serial>
<unique>booyah</unique>
<name>Alice Q. Public</name>
<dataBundle>
<data id=”data”><contact id=”ab43bd44390dabc329192a392bef1” /></data>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#data”>
<DigestMethod Algorithm=“http://www.w3.org/2000/09/xmldsig#sha1”/>
<DigestValue>U1VOQ1QySXpVbXh...QYVVKVllVZFZaMk=</DigestValue>
</Reference>
</SignedInfo>
<SignatureValue>15T1RGamJVNXNTVWRh...Y0dKSFZXZGhXRTFu=</SignatureValue>
</Signature>
</dataBundle>
</proof>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#b5dfaf2d00ca5ef3ed1a2aa7ec23c2db”>
<DigestMethod Algorithm=“http://www.w3.org/2000/09/xmldsig#sha1”/>
<DigestValue>IUe324koV5/A8Q38Gj45i4jddX=</DigestValue>
</Reference>
</SignedInfo>
<SignatureValue>MDAwMDAwMGJ5dGVzLiBQbGVhc2UsIGQ=</SignatureValue>
<KeyInfo><KeyName>CN=identity-validation, S=43438932</KeyName></KeyInfo>
</Signature>
</proofBundle>
</identity>
</identities>
</section>
<Signature xmlns=“http://www.w3.org/2000/09/xmldsig#”>
<SignedInfo>
<SignatureMethod Algorithm=“http://www.w3.org/2000/09/xmldsig#dsa-sha1” />
<Reference URI=“#B”>
<DigestMethod Algorithm=“http://www.w3.org/2000/09/xmldsig#sha1”/>
<DigestValue>UrXLDLBIta6skoV5/A8Q38GEw44=</DigestValue>
</Reference>
</SignedInfo>
<SignatureValue>MC0E~LE=</SignatureValue>
</Signature>
</sectionBundle>
</peer>

In a preferred embodiment, a private dot peer file is used to prove ownership of the public dot peer file. This private dot peer file is never provided to any other peer, however, the file may be optionally stored with a trusted service as the contents are encrypted. The contents of the private dot peer file must be stored in encrypted form in order to prevent unauthorized access to the private key which corresponds to the public key in the public peer file. In a preferred embodiment, the private dot peer file includes two sections—Section A and Section B—an example of which is provided below:

<PrivatePeer version=”10”>
<sectionBundle>
<section id=”A”>
<cipher>sha1/aes256</cipher>
<contact id=”ab43bd44390dabc329192a392bef1” />
<salt>YzY4NWUxMGU4M2ZjNzVkZWQzZTljYWMyNzUzZDAwNG
M4NzE5Yjg1</salt>
<secretProof>NDlkZWI0MzFhYmUxOWQzNWJkNDkzMWZhMzF
mMw==</secretProof>
</section>
<Signature xmlns=“http://www.w3.org/2000/09/xmldsig#”>
<SignedInfo>
<SignatureMethod Algorithm=
“http://www.w3.org/2000/09/xmldsig#dsa-sha1” />
<Reference URI=“#A”>
<DigestMethod Algorithm=“http://www.w3.org/2000/09/xmldsig#sha1” />
<DigestValue>j6lwx3rvEPO0vKtMup4NbeVu8nk=</DigestValue>
</Reference>
</SignedInfo>
<SignatureValue>G4Fwe0E/YT=</SignatureValue>
</Signature>
</sectionBundle>
<sectionBundle>
<section id=”B”>
<encryptedPrivateKey>jk483n2n~3232n/34nk323j...32fsjdneen2311=
</encryptedPrivateKey>
<encryptedPeer>
43j2332944bfdss323bjfjweke2dewbub3i...22dnnewne321~nn32n3j2/44=
</encryptedPeer>
<encryptedContactProfileSecret>
ZWUxZGQz...NjgzMTU3Y2JhZjhhNA==
</encryptedContactProfileSecret>
<encryptedCaptcha>
WkdNME16UXhPRE...JqTVV3WWpNek5tSTROems1T1dVPQ==
</encryptedCaptcha>
<encryptedPrivateData>ZGM0MzQxODBjMTgxMDY2NG
Q4MWE...GUwYjMzNmI4Nzk5OWU=</encryptedPrivateData>
</section>
<Signature xmlns=“http://www.w3.org/2000/09/xmldsig#”>
<SignedInfo>
<SignatureMethod Algorithm=
“http://www.w3.org/2000/09/xmldsig#dsa-sha1” />
<Reference URI=“#B”>
<DigestMethod Algorithm=“http://www.w3.org/2000/09/xmldsig#sha1”/>
<DigestValue>UrXLDLBIta6skoV5/A8Q38GEw44=</DigestValue>
</Reference>
</SignedInfo>
<SignatureValue>MC0E~LE=</SignatureValue>
</Signature>
</sectionBundle>
</PrivatePeer>

One with ordinary skill in the art would readily understand that various encryption techniques and algorithms may be used in the steps described herein—the invention herein is not limited to any particular algorithm or function. Moreover, other factors such as the number of parameters for an algorithm and the party (and number of entities) performing the steps of an algorithm are merely exemplary and not meant to be limiting to the claim language. Various steps as described in the figures and specification may be added or removed from the processes described herein, and the steps described may be performed in an alternative order, consistent with the spirit of the invention.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

1. A method for proving the identity of an owner of a Key within a Key-space, said method comprising:
providing a Key owner with a one-time use value;
receiving from the Key owner a first package, said first package including the one-time use value and a digital signature of exclusively the one-time use value;
receiving from the Key owner a second package, said second package including a public key that corresponds to a previously generated private key, and a digital signature of the public key;
computing a hash value of the second package and comparing said hash value with a previously obtained Key to verify authenticity; and
inputting the one-time use value, the public key, and the digital signature of the one-time use value into a signature-verifying algorithm to verify authenticity, wherein the message to be verified that is input into the signature-verifying algorithm consists of the one-time use value.

2. The method of claim 1, wherein the digital signature of the one-time use value is generated by the Key owner signing the one-time use value using the previously generated private key.

3. The method of claim 1, wherein the second package further comprises random salt, and wherein the digital signature of the public key is generated by the Key owner signing the public key with the random salt using the previously generated private key.

4. The method of claim 3, further comprising inputting the public key with the random salt, the public key, and the digital signature of the public key with the random salt into a signature-verifying algorithm to verify authenticity.

5. A system for proving the identity of an owner of a Key within a Key-space, said system comprising:
a computing device that includes:
a providing module that provides a Key owner with a one-time use value;
a first package receiving module that receives from the Key owner a first package, said first package including the one-time use value and a digital signature of exclusively the one-time use value;
a second package receiving module that receives from the Key owner a second package, said second package including a public key that corresponds to a previously generated private key, and a digital signature of the public key;
a hash value computing and comparison module that computes, via a computer processor, a hash value of the second package and compares said hash value with a previously obtained Key to verify authenticity; and
a first package signature-verifying module that inputs the one-time use value, public key, and the digital signature of the one-time use value into a signature-verifying algorithm to verify authenticity, wherein the message to be verified that is input into the signature-verifying algorithm consists of the one-time use value.

6. The system of claim 5, wherein the digital signature of the one-time use value is generated by the Key owner signing the one-time use value using the previously generated private key.

7. The system of claim 5, wherein the second package further comprises random salt, and wherein the digital signature of the public key is generated by the Key owner signing the public key with the random salt using the previously generated private key.

8. The system of claim 7, further comprising a second package signature-verifying module that inputs the public key with the random salt, the public key, and the digital signature of the public key with the random salt into a signature-verifying algorithm to verify authenticity.

9. A method for providing identity proof of a Key owner through an authentication service, said method comprising:
receiving proof of Key owner authentication from at least one of the Key owner and the authentication service;
receiving a first package from the Key owner, said first package including a publicly available identifier associated with the authentication service, a Key associated with the owner, and a digital signature of exclusively the publicly available identifier and the Key;
using a signing algorithm to sign the first package using a certificate, thereby generating a digital signature of the first package; and
providing a second package to the Key owner, said second package including the first package and the digital signature of the first package.

10. The method of claim 9, wherein the digital signature of the publicly available identifier and the Key is generated by the Key owner signing the publicly available identifier and the Key using a previously generated private key.

11. The method of claim 9, further comprising computing a hash value of the second package and storing said hash value.

12. The method of claim 9, further comprising:
providing the Key owner with a one-time use value;
receiving from the Key owner a third package, said third package including the one-time use value and a digital signature of exclusively the one-time use value;
receiving from the Key owner a fourth package, said fourth package including a public key that corresponds to a previously generated private key, and a digital signature of the public key;
receiving from the Key owner the second package;
computing a hash value of the fourth package and comparing said hash value with a previously obtained Key to verify authenticity;
inputting the one-time use value, the public key, and the digital signature of the one-time use value into a signature-verifying algorithm to verify authenticity; and
inputting the second package and the public key into a signature-verifying algorithm to verify authenticity.

13. The method of claim 12, wherein the digital signature of the one-time use value is generated by the Key owner signing the one-time use value with the previously generated private key.

14. The method of claim 12, wherein the fourth package further comprises random salt, and wherein the digital signature of the public key is generated by the Key owner signing the public key with the random salt using the previously generated private key.

15. The method of claim 14, further comprising inputting the public key with the random salt, the public key, and the digital signature of the public key with the random salt into a signature-verifying algorithm to verify authenticity.

16. A system for providing identity proof of a Key owner through an authentication service, said system comprising:
a computing device that includes:
an authentication receiving module that receives proof of Key owner authentication from at least one of the Key owner and the authentication service;
a first package receiving module that receives a first package from the Key owner, said first package including a publicly available identifier associated with the authentication service, a Key associated with the Key owner, and a digital signature of exclusively the publicly available identifier and the Key;
a digital signature module that uses a signing algorithm to sign the first package via a computer processor using a certificate, thereby generating a digital signature of the first package; and
a second package providing module that provides a second package to the Key owner, said second package including the first package and the digital signature of the first package.

17. The system of claim 16, wherein the digital signature of the publicly available identifier and the Key is generated by the Key owner signing the publicly available identifier and the Key using a previously generated private key.

18. The system of claim 16, further comprising a hash value computing and storage module that computes the hash value of the second package and stores said hash value.

19. The system of claim 16, further comprising:
a value providing module that provides the Key owner with a one-time use value;
a third package receiving module that receives from the Key owner a third package, said third package including the one-time use value and a digital signature of exclusively the one-time use value;
a fourth package receiving module that receives from the Key owner a fourth package, said fourth package including a public key that corresponds to a previously generated private key, and a digital signature of the public key;
a second package receiving module that receives from the Key owner the second package;
a hash value computing and comparison module that computes the hash value of the fourth package and compares said hash value with a previously obtained Key to verify authenticity;
a package signature-verifying module that inputs the one-time use value, the public key, and the digital signature of the one-time use value into a signature-verifying algorithm to verify authenticity; and
a package signature-verifying module that inputs the second package and the public key into a signature-verifying algorithm to verify authenticity.

20. The system of claim 19, wherein the digital signature of the one-time use value is generated by the Key owner signing the one-time use value with the previously generated private key.

21. The system of claim 19, wherein the fourth package further comprises random salt, and wherein the digital signature of the public key is generated by the Key owner signing the public key with the random salt using the previously generated private key.

22. The system of claim 21, further comprising a package signature-verifying module that inputs the public key with the random salt, the public key, and the digital signature of the public key with the random salt into a signature-verifying algorithm to verify authenticity.
